(19) United States
(12) Patent Application Publication
(10) Pub. No.: US 2007/0099049 A1
(43) Pub. Date: May 3, 2007

(54) SUBTERRANEAN FUEL CELL SYSTEM

(76) Inventor: Steven R. Knight, Portland, CT (US)

Correspondence Address: DON W. BULSON (PARKER HANNIFIN);RENNER, OTTO, BOISSELLE & SKLAR, LLP, 1621 EUCLID AVENUE / 19TH FLOOR, CLEVELAND, OH, 44115, US

(21) Appl. No.: 11/553,686

(22) Filed: Oct. 27, 2006

Related U.S. Application Data
(60) Provisional application No. 60/730,900, filed on Oct. 27, 2005.

(51) Int. Cl. H01M 8/02; H01M 8/04

(52) U.S. Cl. 429/26; 429/34

(57) ABSTRACT

A fuel cell system (10) is adapted for positioning within a well (W) dug into the ground. The subterranean fuel cell system (10) comprises a capsule (12) for insertion into the well (W) and for containing a fuel cell stack (14), fuel storage tank (16), and a BOP assembly (18). Cathode air enters the system (10) through an inlet pipe (24) and exits via an exhaust pipe (28). The remaining fluid circuitry (e.g., anode fluid circuit, cooling fluid circuit) can be located within the capsule (12) and/or below the ground level (G) whereby external plumbing, and the need for hoses, tubes, and connections, is minimized. The ground can function as a heat sink for absorbing system heat and as an insulator for preventing freezing of reactant and/or cooling water.

### RELATED APPLICATION

This application claims priority under 35 U.S.C. §119 (e) to U.S. Provisional Patent Application No. 60/730,900, filed on Oct. 27, 2005. The entire disclosure of this provisional application is hereby incorporated by reference.

### GENERAL FIELD

A subterranean fuel cell system comprising a fuel cell stack, a fuel storage container, balance-of-plants components, and fluid circuitry for supplying, exhausting, and/or circulating fluids.

### BACKGROUND

A fuel cell system can comprise a fuel cell stack, a fuel storage container, and balance-of-plants components (pumps, humidifiers, filters, valves, pressure regulators, flow meters, etc.). An anode fluid circuit forms a flow path for anode gas (e.g., hydrogen) through the fuel cell stack and a cathode fluid circuit forms a flow path for cathode gas (e.g., air) through the fuel cell stack. A fuel cell system can be used to provide electrical power when central power plant electrical power is not available. For example, a fuel cell system can be used as backup power for traffic signal lights and/or railroad gates so that they will remain operational when conventional power is discontinued due to outages and/or transmission problems.

### SUMMARY

A fuel cell system is provided that can be positioned within a subterranean well. The system can be constructed to be compact and self-contained, with minimal above-ground hoses, pipes, tubing and/or other plumbing. In this manner, the fuel cell system can be stored in a tamper-prohibiting location, will not occupy a large above-the-ground footprint and, for the most part, can be hidden from view. The ground can function as a heat sink for absorbing system heat and, if the relevant components are positioned below the frost line, an insulator for preventing freezing of reactant and/or cooling water. These and other features of the fuel cell system are fully described and particularly pointed out in the claims. The following description and annexed drawings set forth in detail certain illustrative embodiments, these embodiments being indicative of but a few of the various ways in which the principles may be employed.

### DRAWINGS

FIG. 1 is a schematic drawing of a fuel cell system positioned within a subterranean well.

FIG. 2 is flow circuit showing the passage of cathode air through the fuel cell system.

FIG. 3 is a flow circuit showing the passage of hydrogen-containing fuel through the fuel cell system.

FIG. 4 is a flow circuit showing the passage of cooling fluids through the fuel cell system.

### DETAILED DESCRIPTION

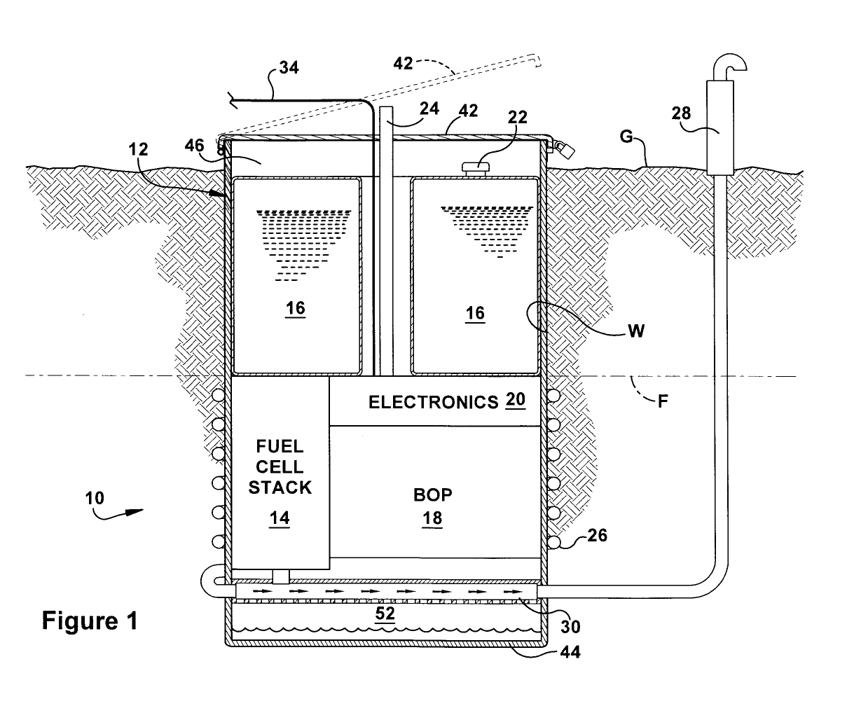

Referring now to the drawings, and initially to FIG. 1, a fuel cell system 10 for positioning within a subterranean well W is shown. The well W can be cylindrical hole dug with readily available augers and preferably has a depth extending below the frost line F. This underground situating of fuel cell system 10 inhibits tampering efforts and does not monopolize above-the-ground space. Also, in many situations, fuel cell system 10 will be hidden from view and not noticed by casual observers. And, as is explained in more detail below, the ground can act both as a sink for absorbing system heat and an insulator for preventing freezing of reactant and/or cooling water.

The fuel cell system 10 comprises a capsule 12, a fuel cell stack 14, a fuel storage container 16, a balance-of-plants (BOP) assembly 18, and an electronics panel (or box) 20. The capsule 12 is shaped and sized for positioning within the well W. The fuel cell stack 14, the fuel storage container 16, the BOP assembly 18 and the electronics panel 20 are contained within the capsule 12.

The fuel cell stack 14 can comprise a series of proton exchange membrane fuel cells and, if so, system operation can be start quickly. This fuel cell type might be preferred because there are no corrosive fluid hazards and/or the thinness of the membrane electrode assemblies can contribute positively to system compactness. In the illustrated embodiment, the cathode fluid comprises air drawn from the surrounding environment and the fuel for the system 10 can be pressurized hydrogen. The fuel storage tank 16 includes a fill port 22 for periodic refilling.

The system 10 further comprises fluid circuitry for supplying, exhausting, and/or circulating fluids. The fluid circuitry includes an air inlet pipe 24, a heat-exchanger tube 26, an air exhaust chimney pipe 28, and a water-separating manifold 30. The cathode fluid (air) enters the system 10 through the inlet pipe 24 and exits the system 10 through the exhaust pipe 28, and both of these pipe cans project above ground level G outside of the capsule 12. The remaining fluid circuitry can be contained within the capsule 12 and/or within the subterranean surrounding the capsule 12 whereby external hoses, fittings, and other fluid plumbing is almost nonexistent.

An electrical connection is provided at each end of the fuel cell stack so as to form a complete circuit (through a load) and an electrical cable 24 is routed from the load to an appropriate medium outside the capsule 12.

The capsule 12 comprises a tubular wall 40, a top wall 42 and a bottom wall 44 defining an interior space. This interior space comprises an upper compartment 46, an intermediate compartment 48, and a lower compartment 50. The fuel fill port 22 can be situated in the upper compartment 46 and the air inlet pipe 24 and the electrical cable 34 can (but need not) extend through this compartment 46. The top wall 42 has a lidded construction whereby it can be opened to gain access to the upper compartment 46 (and thus the fuel fill port 22). A lock or other security measure can be employed to avoid the risk of tampering by unauthorized personnel.

The fuel storage container 16 is situated in the intermediate compartment 48. At least some portions of the intermediate compartment 48, and thus, the container 16 can be positioned above the frost line F. The container 16 can advantageously have an annular (in cross-section) shape following the circumference of the capsule 12. The air inlet pipe 24 and/or the electrical cable 34 can extend through the open central passage of the annular container 16.

The fuel cell stack 14, the BOP assembly 18, and the electronics panel 20 are situated in the lower compartment 50 and, in the illustrated embodiment, below the frost line F. The fuel cell stack 14 can be positioned on one side of the compartment 50 and both the BOP assembly 18 and the electronics panel 20 can be positioned on the other side. The water-separating manifold 30 can be positioned beneath these components and define a water collection pocket 52 in the lowermost region of the compartment 50.

The BOP assembly 18 can comprise a plurality of planar layers assembled in face-to-face contact and joined together in a fluid tight manner. The layers can integrate fluid-conveying channels and/or fluid-interacting devices (pumps, humidifiers, filters, valves, pressure regulators, flow meters, etc.) to form the BOP fluid circuitry for the fuel cell system 10.

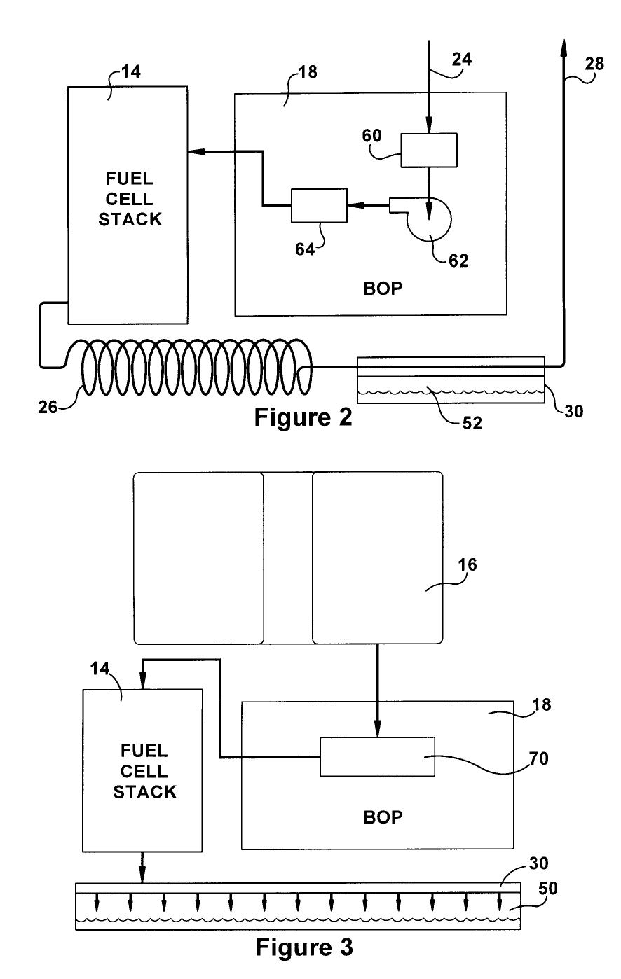

In FIG. 2, the cathode air flow circuit is schematically shown. The BOP assembly 18 can include a filter 60, a compressor 62, and a humidifier 64. Air is drawn by the compressor 62 through the inlet pipe 24 and through the filter 60. The air discharged from the compressor 62 flows through the humidifier 64 and to the fuel cell stack 14. In the fuel cell stack 14, the anode/cathode reaction results in water being produced, this water being in a vapor state due elevated reaction temperatures. This water vapor (along with the pre-reaction humidity carried by the cathode and anode fluids) flows with the air in the cathode exhaust.

The exhaust air from the fuel cell stack 14 (and accumulated water vapor) passes to the heat-exchanger tube 26. The tube 26 is coiled around the lower region of the capsule 12 with the surrounding ground serving as a heat sink to cool the air/vapor mixture. The cooled air then flows through water-separation manifold 30 on route to the chimney pipe 28 whereat it is exhausted to the environment. When passing through the water-separation manifold 30, liquid water drops will fall into the collection pocket 52. The collected water can be used to supply system humidifiers (e.g., cathode humidifier 64 introduced above and/or anode humidifier 70 introduced below). An emergency drain for the pocket 52 and/or a back-up water supply can also be incorporated into the system 10.

In FIG. 3, the anode flow circuit is schematically shown. The hydrogen fuel is conveyed from the container 16, through a humidifier 70 (in the BOP assembly 18) and to the fuel cell stack. The pressure of the fuel will typically be reduced upon exiting the container 16 or shortly thereafter (e.g., within the BOP assembly 18). Any water within the fuel cell (e.g., after operation ceases) will drain to the manifold 30 and then be collected in the pocket 52.

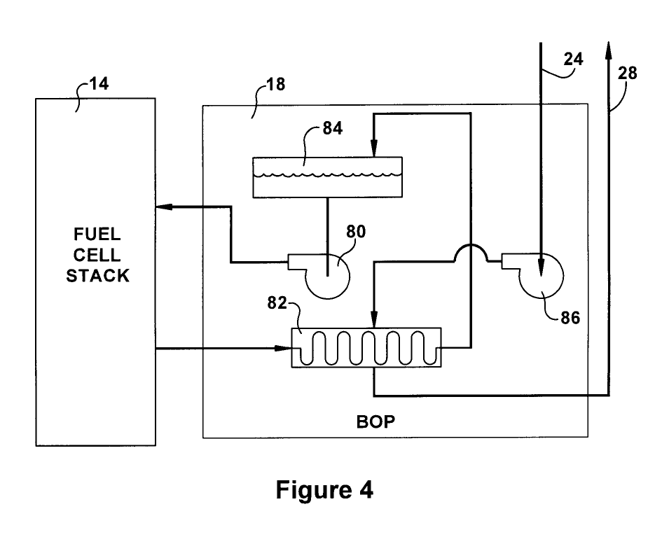

In FIG. 4, the cooling fluid circuits are schematically shown. In the illustrated embodiment, a liquid (e.g., water) is used as the circulating medium and air is used to cool the water as it repeats the cycle through the fuel cell stack 14. It may be noted that if the fuel cell stack 14 and the BOP assembly 18 are located below the frost line F, this will eliminate any risk of freezing, regardless of the season and/or weather conditions. The cooling air can (but does not have to) enter/exit the system 10 through the same passages as the cathode air, specifically air inlet pipe 24 and air exhaust pipe 28 in the illustrated embodiment. The cathode air and the cooling air can travel completely independent paths after entering and prior to exiting.

The cooling liquid can be circulated by a pump 80 through the fuel cell stack 14, through a heat exchanger 82, and then returned to a holding chamber 84 for repeat of the cycle. The cooling air is drawn through inlet pipe 24 by a compressor 86 and pushed through the heat exchanger 82 (wherein it absorbs heat from the circulating liquid) and then exits the system 10 through the exhaust pipe 28. It may be noted that the air could itself be used to as the cooling medium if its heat-absorption qualities are sufficient in a particular fuel cell situation.

As was indicated above, the fuel cell stack 14 can comprise a series of proton exchange membrane fuel cells and the system 10 uses pressurized hydrogen gas as its anode fluid. However, other fuel-cell-system types (e.g., metal-to-air, solid oxide fuel, direct methanol, high temperature, etc.) and/or other fuels (e.g., liquid hydrogen, carbon monoxide, methanol, etc.) are possible and contemplated. Appropriate modifications to BOP components and the fluid circuitry may be necessary to accommodate fuel-cell-type and/or fuel changes, such as those involving the transport of fuel, the management of reaction water, leakage-sealing issues, and/or cooling cycles.

One may now appreciate that the subterranean fuel cell system 10 is tamper-prohibitive, compact, self-contained, space-saving, and can be adapted to have minimal above-ground hoses, pipes, tubing and/or other plumbing. Although the system has been shown and described with respect to a certain embodiment or embodiments, it is obvious that equivalent alterations and modifications will occur to others skilled in the art upon the reading and understanding of this specification and the annexed drawings. In regard to the various functions performed by the above described elements (e.g., components, assemblies, systems, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function. In addition, while a particular feature of the invention may have been described above with respect to only one or more of several illustrated embodiments, such feature may be combined with one or more other features of the other embodiments, as may be desired and advantageous for any given or particular application.

1. A subterranean fuel cell system comprising:
a capsule for positioning within a subterranean well;
a fuel cell stack within the capsule;
a fuel storage container within the capsule;
a balance-of-plant (BOP) assembly within the capsule; and
fluid circuitry for supplying, exhausting, and/or circulating fluids.

2. A subterranean fuel cell system as set forth in claim 1, wherein the capsule comprises a tubular wall and a top wall that may be opened and closed.

3. A subterranean fuel cell system as set forth in claim 2, wherein the fuel storage container comprises a fill port which is accessible when the capsule's top wall is opened.

4. A subterranean fuel cell system as set forth in claim 1, wherein the fuel storage container is positioned above the fuel cell stack within the capsule.

5. A subterranean fuel cell system as set forth in claim 1, wherein the fuel storage container is positioned above the BOP assembly within the capsule.

6. A subterranean fuel cell system as set forth in claim 5, wherein the fuel cell stack is positioned to the side of the BOP assembly.

7. A subterranean fuel cell system as set forth in claim 1, wherein the capsule includes a lower water-collecting pocket.

8. A subterranean fuel cell system as set forth in claim 7, wherein a water-separating manifold communicates with the water-collecting pocket.

9. A subterranean fuel cell system as set forth in claim 8, wherein exhaust fluid flows through the water-separating manifold on route to an exhaust pipe.

10. A subterranean fuel cell system as set forth in claim 1, wherein the fluid circuitry includes an anode fluid circuit from the storage container to the BOP assembly and to the fuel cell stack.

11. A subterranean fuel cell system as set forth in claim 10, wherein the fluid circuitry includes a cathode fluid circuit including an exhaust path from the fuel cell stack to an exhaust pipe.

12. A subterranean fuel cell system as set forth in claim 11, wherein the exhaust path passes through a heat-exchanging tube coiled around the capsule.

13. A subterranean fuel cell system as set forth in claim 12, wherein the exhaust path passes through water-separating means.

14. A subterranean fuel cell system as set forth in claim 1, wherein the fluid circuitry comprises:
an anode fluid circuit from the fuel storage container to the fuel cell stack;
a cathode fluid circuit from an air inlet pipe through the BOP assembly, through the fuel cell stack, and to an exhaust pipe; and
a cooling circuit for circulating a cooling fluid through the fuel cell stack.

15. A subterranean fuel cell system as set forth in claim 14, wherein the cathode fluid circuit passes through a water-separator.

16. A subterranean fuel cell system as set forth in claim 15, wherein the cathode fluid circuit passes through a heat-exchanger coiled around the capsule.

17. A subterranean fuel cell system as set forth in claim 1, wherein the fuel cell stack comprises a series of proton exchange membrane fuel cells.

18. A subterranean fuel cell system as set forth in claim 1, wherein the fuel storage container holds pressurized hydrogen gas.

19. A subterranean fuel cell system as set forth in claim 1, wherein the BOP assembly (18) comprises a plurality of planar layers assembled in face-to-face contact and joined together in a fluid tight manner, the layers integrating fluid-conveying channels and/or fluid-interacting devices forming part of the fluid circuitry.

20. The subterranean fuel cell system set forth in claim 1 positioned within a well dug into a terrain location, wherein the fuel cell stack is positioned below the frost line.
